(19) United States
(12) Patent Application Publication
(10) Pub. No.: US 2014/0267094 A1
(43) Pub. Date: Sep. 18, 2014

(54) PERFORMING AN ACTION ON A TOUCH-ENABLED DEVICE BASED ON A GESTURE

(71) Applicant: Microsoft Corporation, Redmond, WA (US)

(72) Inventors: Daniel J. Hwang, Renton, WA (US); Juan (Lynn) Dai, Sammamish, WA (US); Sharath Viswanathan, Seattle, WA (US); Joseph B. Tobens, Seattle, WA (US); Jose A. Rodriguez, Seattle, WA (US)

(21) Appl. No.: 13/918,238

(22) Filed: Jun. 14, 2013

Related U.S. Application Data
(63) Continuation-in-part of application No. 13/801,665, filed on Mar. 13, 2013.

(51) Int. Cl. G06F 3/0488

(52) U.S. Cl. CPC G06F 3/0488
USPC 345/173

(57) ABSTRACT

Techniques are described herein that are capable of performing an action on a touch-enabled device based on a gesture. A gesture (e.g., a hover gesture, a gaze gesture, a look-and-blink gesture, a voice gesture, a touch gesture, etc.) can be detected and an action performed in response to the detection. A hover gesture can occur without a user physically touching a touch screen of a touch-enabled device. Instead, the user's finger or fingers can be positioned at a spaced distance above the touch screen. The touch screen can detect that the user's fingers, palm, etc. are proximate to the touch screen, such as through capacitive sensing. Additionally, finger movement can be detected while the fingers are hovering to expand the existing options for gesture input.

### CROSS-REFERENCE TO RELATED APPLICATION(S)

This application is a continuation-in-part of U.S. patent application Ser. No. 13/801,665, filed Mar. 13, 2013, the entirety of which is incorporated by reference herein.

### BACKGROUND

Touch screens have had enormous growth in recent years. Touch screens are now common in places such as kiosks at airports, automatic teller machines (ATMs), vending machines, computers, mobile phones, etc.

The touch screens typically provide a user with a plurality of options through icons, and the user can select those icons to launch an application or obtain additional information associated with the icon. If the result of that selection did not provide the user with the desired result, then he/she must select a “back” button or “home” button or otherwise back out of the application or information. Such unnecessary reviewing of information costs the user time. Additionally, for mobile phone users, battery life is unnecessarily wasted.

Additionally, the library of touch gestures is limited. Well-known gestures include a flick, pan, pinch, etc., but new gestures have not been developed, which limits the functionality of a mobile device.

### SUMMARY

Various approaches are described herein for, among other things, performing an action on a touch-enabled device based on a gesture. A gesture, such as a hover gesture, can be detected and an action performed in response to the detection. A hover gesture can occur without a user physically touching a touch screen of a touch-enabled device. Instead, the user's finger or fingers can be positioned at a spaced distance above the touch screen. The touch screen can detect that the user's fingers are proximate to the touch screen, such as through capacitive sensing. Additionally, finger movement can be detected while the fingers are hovering to expand the existing options for gesture input.

Example methods are described. In accordance with a first example method, a gesture (e.g., a hover gesture) is detected with regard to a designated virtual element. The gesture is a user command to perform an action associated with the designated virtual element (e.g., to provide a preview of information associated with the designated virtual element). The action is performed (e.g., without activating the designated virtual element to access the information).

In accordance with a second example method, finger(s) are detected in a hover position. The finger(s) are a spaced distance from a touch screen. A hover gesture is detected with regard to a virtual element on the touch screen. The hover gesture is a user command to perform an action associated with the virtual element. The hover gesture occurs without touching the touch screen. The action is performed based on the hover gesture.

Example systems are also described. A first example system includes a gesture engine, a rendering engine, and an operating system. The gesture engine is configured to detect a gesture with regard to a designated virtual element. The gesture is a user command to provide a preview of information associated with the designated virtual element. The rendering engine is configured to provide the preview of the information without the operating system activating the designated virtual element to access the information.

A second example system includes a touch screen sensor, a gesture engine, and a component, which may include a rendering engine and/or an operating system. The touch screen sensor detects finger(s) in a hover position. The finger(s) are a spaced distance from a touch screen. The gesture engine detects a hover gesture with regard to a virtual element on the touch screen. The hover gesture is a user command to perform an action associated with the virtual element. The hover gesture occurs without touching the touch screen. The component performs the action based on the hover gesture.

A third example system includes a gesture engine and a component, which may include a rendering engine and/or an operating system. The gesture engine detects a hover gesture with regard to a virtual element on a touch screen. The hover gesture is a user command to perform an action associated with the virtual element. The component performs the action based on the hover gesture.

A computer program product is also described. The computer program product includes a computer-readable medium having computer program logic recorded thereon for enabling a processor-based system to performing an action based on a gesture. The computer program product includes a first program logic module and a second program logic module. The first program logic module is for enabling the processor-based system to detect a gesture (e.g., a hover gesture) with regard to a designated virtual element. The gesture is a user command to perform an action associated with the designated virtual element (e.g., provide a preview of information associated with the designated virtual element). The second program logic module is for enabling the processor-based system to perform the action (e.g., without activating the designated virtual element to access the information).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is \noted that the invention is not limited to the specific embodiments described in the \/sDetailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a system diagram of an exemplary mobile device with a touch screen for sensing a finger gesture.

FIG. 2 is an illustration of exemplary system components that can be used to receive finger-based hover input.

FIG. 3 is an example of displaying a missed call using a hover input.

FIG. 4 is an example of displaying a calendar event using a hover input.

FIG. 5 is an example of scrolling through different displays on a weather icon using a hover input.

FIG. 6 is an example of displaying additional information above the lock using a hover input.

FIG. 7 is an example of displaying a particular day on a calendar using a hover input.

FIG. 8 is an example of displaying a system settings page using a hover input.

FIG. 9 is an example of scrolling in a web browser using a hover input.

FIG. 10 is an example of highlighting text using a hover input.

FIG. 11 is an example of displaying a recent browsing page using the hover input.

FIG. 12 is an example of using a hover input in association with a map application.

FIG. 13 is an example of using hover input to zoom in a map application.

FIG. 14 is an example of using hover input to answer a phone call.

FIG. 15 is an example of displaying additional content associated with an icon using hover input.

FIG. 16 is an example of some of the hover input gestures that can be used.

FIG. 17 is a flowchart of a method for detecting and performing an action based on a hover gesture.

FIG. 18 is a flowchart of a method for detecting and performing an action based on a hover gesture.

FIGS. 19-21 depict flowcharts of example methods for performing actions based on gestures in accordance with embodiments.

FIG. 22 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Example Embodiments

Example embodiments described herein are capable of receiving user input on a touch screen or other touch responsive surfaces. Examples of such touch responsive surfaces include materials which are responsive to resistance, capacitance, or light to detect touch or proximity gestures. A hover gesture can be detected and an action performed in response to the detection. The hover gesture can occur without a user physically touching a touch screen. Instead, the user's finger or fingers can be positioned at a spaced distance above the touch screen. The touch screen can detect that the user's fingers are proximate to the touch screen, such as through capacitive sensing. Additionally, finger movement can be detected while the fingers are hovering to expand the existing options for gesture input.

Example techniques described herein have a variety of benefits as compared to conventional techniques for receiving user input on a touch screen. For example, the techniques may be capable of providing a preview of information that is associated with a virtual element, upon detecting a gesture with regard to the virtual element, without activating the virtual element to access the information. In accordance with this example, the preview may be provided without launching a software program (or an instance thereof) associated with the virtual element on an operating system to access the information and without opening an item that is included in a software program associated with the virtual element on an operating system (or more generally executable on a general or special purpose processor) to access the information. Accordingly, a user may peek at the preview before determining whether to activate the virtual element. The preview may be viewed relatively quickly, without losing a current context in which the virtual element is shown, and/or without using option(s) in an application bar. The example techniques may be capable of performing any of a variety of actions based on hover gestures. Such hover gestures need not necessarily be as precise as some other types of gestures (e.g., touch gestures) to perform an action.

Embodiments described herein focus on a mobile device, such as a mobile phone. However, the described embodiments can be applied to any device with a touch screen or a touch surface, including laptop computers, tablets, desktop computers, televisions, wearable devices, etc.

Hover Touch is built into the touch framework to detect a finger above-screen as well as to track finger movement. A gesture engine can be used for the recognition of hover touch gestures, including as examples: (1) finger hover pan—float a finger above the screen and pan the finger in any direction; (2) finger hover tickle/flick—float a finger above the screen and quickly flick the finger as like a tickling motion with the finger; (3) finger hover circle—float a finger or thumb above the screen and draw a circle or counter-circle in the air; (4) finger hover hold—float a finger above the screen and keep the finger stationary; (5) palm swipe—float the edge of the hand or the palm of the hand and swipe across the screen; (6) air pinch/lift/drop—use the thumb and pointing finger to do a pinch gesture above the screen, drag, then a release motion; (7) hand wave gesture—float hand above the screen and move the hand back and forth in a hand-waving motion.

The hover gesture relates to a user-input command wherein the user's hand (e.g., one or more fingers, palm, etc.) is a spaced distance from the touch screen meaning that the user is not in contact with the touch screen. Moreover, the user's hand should be within a close range to the touch screen, such as between 0.1 to 0.25 inches, or between 0.25 inches and 0.5 inches, or between 0.5 inches and 0.75 inches or between 0.75 inches and 1 inch, or between 1 inch and 1.5 inches, etc. Any desired distance can be used, but in many embodiments generally such a distance can be less than 2 inches.

A variety of ranges can be used. The sensing of a user's hand can be based on capacitive sensing, but other techniques can be used, such as an ultrasonic distance sensor or camera-based sensing (images taken of user's hand to obtain distance and movement).

Once a hover touch gesture is recognized, certain actions can result, as further described below. Allowing for hover recognition significantly expands the library of available gestures to implement on a touch screen device.

FIG. 1 is a system diagram depicting an exemplary mobile device 100 including a variety of optional hardware and software components, shown generally at 102. Any components 102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 104, such as a cellular or satellite network, or with a local area or wide area network.

The illustrated mobile device 100 can include a controller or processor 110 (e.g., signal processor, microprocessor, ASIC, or other control and processing logic circuitry) for performing such tasks as signal coding, data processing, input/output processing, power control, and/or other functions. An operating system 112 can control the allocation and usage of the components 102 and support for one or more application programs 114. The application programs can include common mobile computing applications (e.g., email applications, calendars, contact managers, web browsers, messaging applications), or any other computing application.

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the applications 114. Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 100 can support one or more input devices 130, such as a touch screen 132, microphone 134, camera 136, physical keyboard 138 and/or trackball 140 and one or more output devices 150, such as a speaker 152 and a display 154. Touch screens, such as touch screen 132, can detect input in different ways. For example, capacitive touch screens detect touch input when an object (e.g., a fingertip) distorts or interrupts an electrical current running across the surface. As another example, touch screens can use optical sensors to detect touch input when beams from the optical sensors are interrupted. Physical contact with the surface of the screen is not necessary for input to be detected by some touch screens. For example, the touch screen 132 can support a finger hover detection using capacitive sensing, as is well understood in the art. Other detection techniques can be used, as already described above, including camera-based detection and ultrasonic-based detection. To implement a finger hover, a user's finger is typically within a predetermined spaced distance above the touch screen, such as between 0.1 to 0.25 inches, or between 0.25 inches and 0.05 inches, or between 0.5 inches and 0.75 inches or between 0.75 inches and 1 inch, or between 1 inch and 1.5 inches, etc.

Other possible output devices (not shown) can include piezoelectric or other haptic output devices. Some devices can serve more than one input/output function. For example, touch screen 132 and display 154 can be combined in a single input/output device. The input devices 130 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 112 or applications 114 can comprise speech-recognition software as part of a voice user interface that allows a user to operate the device 100 via voice commands. Further, the device 100 can comprise input devices and software that allows for user interaction via a user's spatial gestures, such as detecting and interpreting gestures to provide input to a gaming application.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth 164 or Wi-Fi 162). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 180, a power supply 182, a satellite navigation system receiver 184, such as a Global Positioning System (GPS) receiver, an accelerometer 186, and/or a physical connector 190, which can be a USB port, IEEE 1394 (FireWire) port, and/or RS-232 port. The illustrated components 102 are not required or all-inclusive, as any components can be deleted and other components can be added as would be recognized by one skilled in the art.

FIG. 2 is a system diagram showing further details of components that can be used to implement a hover user input. A touch screen sensor 210 can detect a finger hover at a spaced distance (i.e., a non-zero distance) above the touch screen. Some examples of such technology are available from Cypress Semiconductor Corp.®, although other systems that provide similar detection functionality are known in the art. A gesture engine 212 can receive input from the touch screen sensor to interpret user input including one or more fingers in a hover position (a position at a distance above the touch screen) and a hover gesture (a user input command to perform an action). A hover gesture can include a user finger remaining in a fixed position for a predetermined period of time or some predetermined finger movement. Some predetermined finger movements can include a tickle movement, wherein the user moves his/her fingertip back and forth in a rapid motion to mimic tickling, or a circle movement, or a check movement (like a user is checking a box), etc. Specific gestures include, but are not limited to (1) finger hover pan—float a finger above the screen and pan the finger in any direction; (2) finger hover tickle/flick—float a finger above the screen and quickly flick the finger as like a tickling motion with the finger; (3) finger hover circle—float a finger or thumb above the screen and draw a circle or counter-circle in the air; (4) finger hover hold—float a finger above the screen and keep the finger stationary; (5) palm swipe—float the edge of the hand or the palm of the hand and swipe across the screen; (6) air pinch/lift/drop—use the thumb and pointing finger to do a pinch gesture above the screen, drag, then a release motion; (7) hand wave gesture—float hand above the screen and move the hand back and forth in a hand-waving motion. With each of these gestures, the user's fingers do not touch the screen.

Once the gesture engine interprets the gesture, the gesture engine 212 can alert an operating system 214 of the received gesture. In response, the operating system 214 can perform some action and display the results using a rendering engine 216.

FIG. 3 is an example of displaying a missed call using a hover input. As shown, a user's finger is spaced above a touch screen 310 by a non-zero distance 312 to represent a hover mode. In particular, the user's finger is placed above an icon 316 that indicates one or more calls were missed (e.g., an icon that indicates the number of missed calls, but not the callers associated with those calls). If the user leaves his/her finger in the same hover mode for a predetermined period of time (e.g., 1 second), then a hover gesture is detected, which is a user command to perform an action. In response, the icon dynamically changes as shown at 320 to display additional information about the missed call. If the person's name that called and his/her picture are in the phone's contacts list, the additional information can be a photo of the person, the name of the person, etc. If the user maintains the hover gesture, then multiple missed calls can be displayed one at a time in a round-robin fashion. Once the finger is removed, the icon returns to its previous state as shown at 316. Thus, a hover gesture can be detected in association with an icon and additional information can be temporarily displayed in association with the icon.

FIG. 4 is an example of displaying a calendar event using a hover gesture. As shown at 410, a hover mode is first entered when a user places his/her finger over an icon. The icon can be highlighted in response to entering the hover mode. If the user continues to maintain his/her finger in the hover mode for a predetermined period of time, then a hover gesture is detected. In response, a calendar panel is displayed at 420 showing the current days activities. The calendar panel can overlap other icons, such as a browser icon and a weather icon. Once the finger is removed, the panel 420 automatically disappears without requiring an additional user touch. Thus, a hover gesture can be detected in association with a calendar icon to display additional information stored in association with the calendar application. Example additional information can include calendar events associated with the current day.

FIG. 5 is an example of interacting with an application icon 510. The illustrated application is a weather application. If a hover gesture is detected, then the application icon dynamically cycles through different information. For example, the application icon 510 can dynamically be updated to display Portland weather 512, then Seattle weather 514, then San Francisco weather 516, and repeat the same. Once the user's finger is removed, the icon ceases to cycle through the different weather panels. Thus, a hover gesture can be detected in association with a weather application to show additional information about the weather, such as the weather in different cities.

FIG. 6 shows an example of displaying additional information on a lock screen above the lock using a hover input. As shown at 610, at least one user finger is detected in a hover position, the finger being at a spaced distance (i.e., non-zero) from the touch screen. The touch screen is displaying that there is a message to be viewed, and the user's finger is hovering above the message indication. If the user performs a hover gesture, then the message is displayed over the lock screen as shown at 612 in a message window. The hover gesture can be simply maintaining the user's finger in a fixed position for a predetermined period of time. Once the user's finger is removed (i.e., further than a predetermined distance from the message indication), then the message window is removed. Although a message indication is shown for an above-lock function, other indications can also be used, such as new email indications (hover and display one or more emails), calendar items (hover to display more information about a calendar item), social networking notifications (hover to see more information about the notification), etc.

FIG. 7 is an example of displaying a particular day on a calendar application using a hover gesture. At 710, a calendar application is shown with a user performing a hover command above a particular day in a monthly calendar. As a result, the detailed agenda for that day is displayed overlaying or replacing the monthly calendar view, as shown at 712. Once the user's finger is removed from the hover position, the monthly calendar view 710 is again displayed. Another hover gesture that can be used with a calendar is to move forward or backward in time, such as by using an air swiping hover gesture wherein the user's entire hand hovers above the touch screen and moves right, left, up or down. In a day view, such a swiping gesture can move to the next day or previous day, to the next week or previous week, and so forth. In any event, a user can perform a hover command to view additional detailed information that supplements a more general calendar view. And, once the user discontinues the hover gesture, the detailed information is removed and the more general calendar view remains displayed.

FIG. 8 is an example of displaying a system settings page using a hover gesture. From any displayed page, the user can move his/her hand into a hover position and perform a hover gesture near the system tray 810 (a designated area on the touch screen). In response, a system setting page 812 can be displayed. If the user removes his/her finger, then the screen returns to its previously displayed information. Thus, a user can perform a hover gesture to obtain system settings information.

FIG. 9 is an example of scrolling in a web browser using a hover gesture. A web page is displayed, and a user places his/her finger at a predetermined position, such as is shown at 910, and performs a hover gesture. In response, the web browser automatically scrolls to a predetermined point in the web page, such as to a top of the web page, as is shown at 920. Alternatively, the scrolling can be controlled by a hover gesture, such as scrolling at a predetermined rate and in a predetermined direction.

FIG. 10 is an example of selecting text using a hover input. As shown at 1010, a user can perform a hover gesture above text on a web page. In response, a sentence being pointed at by the user's finger is selected, as shown at 1012. Once selected, additional operations can be performed, such as copy, paste, cut, etc. Thus, a hover gesture can be used to select text for copying, pasting, cutting, etc.

FIG. 11 is an example of displaying a list of recently browsed pages using the hover input. A predetermined hover position on any web page can be used to display a list of recently visited websites. For example, at 1110, a user can perform a hover gesture at a bottom corner of a webpage in order to display a list of recently visited sites, such as is shown at 1120. The user can either select one of the sites or remove his/her finger to return to the previous web page. Thus, the hover command can be used to view recent history information associated with an application.

FIG. 12 is an example of using a hover gesture in association with a map application. At 1210, a user performs a hover gesture over a particular location or point of interest on a displayed map. In response, a pane 1220 is displayed that provides additional data about the location or point of interest to which the user points. As in all of the above examples, if the user moves his/her finger away from the touch screen, then the map 1210 returns to being viewed, without the user needing to touch the touch screen. Thus, a hover gesture can be used to display additional information regarding an area of the map above which the user is hovering. Furthermore, FIG. 12 illustrates that when content is being displayed in a page mode, the user can perform a hover command above any desired portion of the page to obtain further information.

FIG. 13 is an example of using hover input to zoom in a map application. At 1310, a mobile device is shown with a map being displayed using a map application. As shown at 1312, a user performs a hover gesture, shown as a clockwise circle gesture around an area into which a zoom is desired. The result is shown at 1320 wherein the map application automatically zooms in response to receipt of the hover gesture. Zooming out can also be performed using a gesture, such as a counterclockwise circle gesture. The particular gesture is a matter of design choice. However, a user can perform a hover gesture to zoom in and out of a map application.

FIG. 14 is an example of using hover input to answer a phone call. If a user is driving and does not want to take his/her eyes off of the road to answer a phone call, the user can perform a hover gesture, such as waving a hand above the touch screen as indicated at 1410. In response, the phone call is automatically answered, as indicated at 1420. In one example, the automatic answering can be to automatically place the phone is a speakerphone mode, without any further action by the user. Thus, a user gesture can be used to answer a mobile device after a ringing event occurs.

FIG. 15 is an example of displaying additional content associated with an icon using a hover gesture. At 1510, a user performs a hover gesture over an icon on a mobile device. In response, as shown at 1520, additional content is displayed associated with the icon. For example, the icon can be associated with a musical artist and the content can provide additional information about the artist.

FIG. 16 provides examples of different hover gestures that can be used. A first hover gesture 1610 is a circle gesture wherein the user's finger moves in a circular motion. Clockwise circle gestures can be interpreted as different than counterclockwise gestures. For example, a counterclockwise circular gesture can be interpreted as doing an opposite of the clockwise circular gesture (e.g., zoom in and zoom out). A second hover gesture 1620 is shown as a tickle motion wherein a user's fingertip moves in a back-and-forth motion. Although not shown in FIG. 16, a third hover gesture is where a user's pointer finger is maintained in the same hover position for more than a predetermined period of time. Other hover gestures can be used, such as a user tracing out a check mark over the screen, for example. In any event, multiple of the hover gestures detect a predefined finger motion at a spaced distance from the touch screen. Other hover gestures can be a quick move in and out without touching the screen. Thus, the user's finger enters and exits a hover zone within a predetermined time period. Another hover gesture can be a high-velocity flick, which is a finger traveling at a certain minimal velocity over a distance. Still another hover gesture is a palm-based wave gesture.

Other example applications of the hover gesture can include having UI elements appear in response to the hover gesture, similar to a mouse-over user input. Thus, menu options can appear, related contextual data surfaced, etc. In another example, in a multi-tab application, a user can navigate between tabs using a hover gesture, such as swiping his or her hand. Other examples include focusing on an object using a camera in response to a hover gesture, or bringing camera options onto the UI (e.g., flash, video mode, lenses, etc.) The hover command can also be applied above capacitive buttons to perform different functions, such as switching tasks. For example, if a user hovers over a back capacitive button, the operating system can switch to a task switching view. The hover gesture can also be used to move between active phone conversations or bring up controls (fast forward, rewind, etc.) when playing a movie or music. In still other examples, a user can air swipe using an open palm hover gesture to navigate between open tabs, such as in a browser application. In still other examples, a user can hover over an entity (name, place, day, number, etc.) to surface the appropriate content inline, such as displaying addition information inline within an email. Still further, in a list view of multiple emails, a hover gesture can be used to display additional information about a particular email in the list. Further, in email list mode, a user can perform a gesture to delete the email or display different action buttons (forward, reply, delete). Still further, a hover gesture can be used to display further information in a text message, such as emoji in a text message. In messaging, hover gestures, such as air swipes can be used to navigate between active conversations, or preview more lines of a thread. In videos or music, hover gestures can be used to drag sliders to skip to a desired point, pause, play, navigate, etc. In terms of phone calls, hover gestures can be used to display a dialog box to text a sender, or hover over an “ignore” button to send a reminder to call back. Additionally, a hover command can be used to place a call on silent. Still further, a user can perform a hover gesture to navigate through photos in a photo gallery. Hover commands can also be used to modify a keyboard, such as changing a mobile device between left-handed and right-handed keyboards. As previously described, hover gestures can also be used to see additional information in relation to an icon.

FIG. 17 is a flowchart of an embodiment for receiving user input on a touch screen. In process block 1710, at least one finger or other portion of a user's hand is detected in a hover position. A hover position is where one or more fingers are detected above the touch screen by a spaced distance (which can be any distance whether it be predetermined or based on reception of a signal), but without physically touching the touch screen. Detection means that the touch sensor recognizes that one or more fingers are near the touch screen. In process block 1720, a hover gesture is detected. Different hover gestures were already described above, such as a circle gesture, hold gesture, tickle gesture, etc. In process block 1730, an action is performed based on the hover gesture. Any desired action can occur, such as displaying additional information (e.g., content) associated with an icon, displaying calendar items, automatic scrolling, etc. Typically, the additional information is displayed in a temporary pop-up window or sub-window or panel, which closes once the touch screen no longer detects the user's finger in the hover position.

FIG. 18 is a flowchart of a method according to another embodiment. In process block 1810, a hover mode is entered when a finger is detected in a hover position at a spaced distance from the touch screen. In some embodiments, once the hover mode is entered, then hover gestures can be received. In process block 1820, a hover gesture is detected indicating that a user wants an action to be performed. Example actions have already been described herein. In process block 1830, the hover gesture is interpreted as a user input command, which is performed to carry out the user's request.

Some of the embodiments described above are discussed with reference to icons for illustrative purposes. For instance, each of FIGS. 3-5 and 15 illustrates a touch screen having a plurality of icons displayed thereon. A user may interact with one or more of the icons by placing one or more fingers in a hover position proximate the icon(s) and/or performing a hover gesture with respect to the icon(s). It should be noted that each of the icons also constitutes an example of a virtual element. Examples of a virtual element include but are not limited to a graphical and/or textual representation of a person, place, thing, or time (or a list or combination of persons, places, things, or times). For instance, a thing may be a point of interest on a map, a computer program, a song, a movie, an email, or an event. It will be recognized that a graphical representation may be a photograph or a drawing, for example. The embodiments described below are discussed with reference to such virtual elements for illustrative purposes.

FIGS. 19-21 depict flowcharts of example methods for performing actions based on gestures in accordance with embodiments. Flowcharts 1900, 2000, and 2100 may be performed by a mobile device, such as mobile device 100 shown in FIG. 1. It will be recognized that such a mobile device may include any one or more of the system components shown in FIG. 2. For instance, the mobile device may include touch screen sensor 210, gesture engine 212, operating system 214, and/or rendering engine 216. For illustrative purposes, flowcharts 1900, 2000, and 2100 are described with respect to the system components shown in FIG. 2. Further structural and operational embodiments will be apparent to persons skilled in the relevant art(s) based on the discussion regarding flowcharts 1900, 2000, and 2100.

As shown in FIG. 19, the method of flowchart 1900 begins at step 1902. In step 1902, a gesture is detected with regard to a designated virtual element. The gesture is a user command to provide a preview of information associated with the designated virtual element. Examples of a gesture include but are not limited to a hover gesture (e.g., waving a hand, pointing, hovering for at least a threshold period of time, flicking a finger, swiping a palm or finger(s) of the hand, pinching fingers together, moving fingers apart, etc. without touching the touch screen), a gaze gesture (e.g., gazing for at least a threshold period of time), a look-and-blink gesture (e.g., blinking while looking), a voice gesture (e.g., saying a command), a touch gesture (e.g., tapping a finger, swiping a finger, pinching fingers together, moving fingers apart, etc. against the touch screen), etc. or any combination thereof. In an example implementation, gesture engine 212 detects the gesture.

It should be noted that the preview of the information is not a tooltip (a.k.a. screentip or balloon help), which is a description of a function of a virtual element with which the tooltip is associated. Rather, such a preview includes contextual information that is traditionally accessible by causing the function of the virtual element to be executed, including causing a software application to be launched (or an item that is included in the software application to be opened) on an operating system to access the contextual information. In certain embodiments, such contextual information may be periodically updated and stored by a virtual element and available to be rendered when an interaction with the virtual element by a hover gesture is detected.

The designated virtual element is included in a plurality of virtual elements that are displayed on a touch screen. For instance, the plurality of virtual elements may be included in a webpage, a map, a message (e.g., a social update, an email, a short message service (SMS), an instant message (IM), or an online chat message) or a list of multiple messages, a calendar, or otherwise.

At step 1904, the preview of the information is provided (e.g., automatically provided) without activating the designated virtual element to access the information. Activating the designated virtual element means launching a software program (or an instance thereof) associated with the designated virtual element on an operating system (e.g., operating system 214) or opening an item that is included in a software program associated with the designated virtual element on an operating system. Accordingly, providing the preview of the information at step 1904 may include using features of an operating system to provide the preview, so long as a software program associated with the designated virtual element is not launched on an operating system based on the gesture to access the information and no items that are included in a software program associated with the designated virtual element are opened on an operating system based on the gesture to access the information.

For example, if the designated virtual element represents an email, providing a preview of the email does not include launching an email program on an operating system to access content of the email and does not include opening the email on an operating system to access the content of the email.

In another example, if the designated virtual element represents a movie, providing a video preview of the movie does not include launching a media player program on an operating system to access content of the movie.

In yet another example, if the designated virtual element is a hyperlink to a webpage, providing a preview of the webpage does not include launching a web browser on an operating system to access content of the webpage and does not include opening a tab in a browser on an operating system to access the content of the webpage.

These and other examples are described in greater detail below with respect to various embodiments.

The preview of the information is provided at step 1904 based on detecting the gesture with regard to the designated virtual element at step 1902. Any suitable technique may be used to provide the preview of the information. For instance, the preview may be provide audibly (e.g., via a speaker in or connected to a device that includes the touch screen) or visually (e.g., via the touch screen). In an example implementation, rendering engine 216 provides (e.g., renders) the preview of the information.

In a first example embodiment, providing the preview at step 1904 includes increasing a size of the designated virtual element to include the preview of the information. In an aspect of this embodiment, the plurality of virtual elements is a plurality of respective quadrilaterals. For instance, the quadrilaterals may be parallelograms (e.g., rectangles, squares, rhombus, etc. or any combination thereof). In accordance with this aspect, the designated virtual element is a designated quadrilateral. In further accordance with this aspect, providing the preview at step 1904 includes increasing the size of the designated quadrilateral. For instance, providing the preview may include showing an animation in which the designated virtual element is unfolded from a first size to a second size, wherein the second size is greater than the first size. In one example of this aspect, a relatively small email tile, which identifies an email program, in a tiled user interface on the touch screen may be unfolded into a relatively larger email tile to show one or more received emails (e.g., a last email received). In another example of this aspect, a relatively small movie tile, which identifies a movie service, may be unfolded to a relatively larger movie tile, which shows one or more movie times (e.g., a list of movie times) at which each currently available movie is to be shown (e.g., in a geographical location within a designated distance from a location associated with a user who provides the gesture with regard to the designated virtual element.

In a second example embodiment, the designated virtual element represents a point of interest on a map. Examples of a point of interest include but are not limited to a geographic region (e.g., a city, a county, a state, or a country), a landmark (e.g., a mountain, a monument, a building such as a store or a dwelling, an intersection of streets, or a body of water), etc. In one aspect of this embodiment, providing the preview at step 1904 includes providing a magnified view of the point of interest. In another aspect of this embodiment, providing the preview at step 1904 includes providing transit information regarding a route to the point of interest. In accordance with this aspect, the transit information may include real-time traffic information regarding traffic along the route (e.g., indicating congestion and/or delays), available automobile (e.g., bus or taxi) trip(s), airplane trip(s), hiking trails, bicycle trails, etc. to the point of interest or any combination thereof. In yet another aspect of this embodiment, providing the preview at step 1904 includes providing a list of persons in a social network of a user who provided the gesture who are located at the point of interest or within a threshold distance from the point of interest. In still another aspect of this embodiment, providing the preview at step 1904 includes providing historical facts about the point of interest.

In a third example embodiment, the designated virtual element is a textual representation of a day, a name, a place, an event, or an address in a textual message. In accordance with this embodiment, providing the preview at step 1904 includes providing a preview of information associated with the day, the name, the place, the event, or the address. Examples of a textual message include but are not limited to a social update, an email, a short message service (SMS), an instant message (IM), an online chat message, etc.

In a fourth example embodiment, the designated virtual element represents a plurality of calendar entries with regard to a specified time period. A calendar entry may correspond to an appointment, a meeting, an event, etc. Two or more of the calendar entries may overlap with respect to time in the specified time period, though the scope of the example embodiments is not limited in this respect. In accordance with this embodiment, providing the preview at step 1904 includes successively providing a preview of information regarding each of the plurality of calendar entries (e.g., one at a time in a round-robin fashion). For instance, a preview of information regarding a first calendar entry may be provided for a first period of time, then a preview of information regarding a second calendar entry may be provided for a second time period, then a preview of information regarding a third calendar entry may be provided for a third time period, and so on.

In a fifth example embodiment, the designated virtual element represents a day in a depiction of a calendar. In an aspect, the depiction of the calendar is a depiction of a month view of the calendar, wherein the month view represents a single month of a year. In accordance with this aspect, the day in the depiction is in the month represented by the month view. In another aspect, the depiction of the calendar is a depiction of a week view of the calendar, wherein the week view represents a single week of a month. In accordance with this aspect, the day in the depiction is in the week represented by the week view. In accordance with this embodiment, providing the preview at step 1904 includes providing a preview of a plurality of calendar entries that are associated with the day.

In a sixth example embodiment, the designated virtual element represents a specified calendar entry, which is included in a plurality of calendar entries that are associated with a common date, in a depiction of a calendar. In accordance with this embodiment, providing the preview at step 1904 includes providing a preview of information regarding each of the plurality of calendar entries.

In a seventh example embodiment, the designated virtual element is included in a depiction of a calendar and includes first information regarding weather in a specified geographic location. In accordance with this embodiment, providing the preview at step 1904 includes providing a preview of second information regarding the weather in the specified geographic location. At least some of the second information in the preview is not included in the first information.

In an eighth example embodiment, the plurality of virtual elements represents a plurality of respective messages. In accordance with this embodiment, the designated virtual element represents a designated message. In further accordance with this embodiment, providing the preview at step 1904 includes providing more content of the designated message than the designated virtual element provides prior to the preview being provided. In an aspect of this embodiment, providing the preview at step 1904 includes providing more content of the designated message than the designated virtual element provides after the preview is provided, as well.

In a ninth example embodiment, the designated virtual element represents a photograph. In accordance with this embodiment, providing the preview at step 1904 includes displaying the photograph on the touch screen.

In a tenth example embodiment, the designated virtual element represents an emoji. In accordance with this embodiment, providing the preview at step 1904 includes displaying an instance of the emoji that is larger than an instance of the emoji that is included in the designated virtual element prior to the preview being provided.

In an eleventh example embodiment, the plurality of virtual elements represents a plurality of respective movies. In accordance with this embodiment, the designated virtual element represents a designated movie. In further accordance with this embodiment, providing the preview at step 1904 includes providing a video preview of the designated movie.

In a twelfth example embodiment, the designated virtual element is a virtual button configured to, upon activation of the designated virtual element, skip to a next song in a playlist of songs. In accordance with this embodiment, providing the preview at step 1904 includes providing identifying information that identifies the next song. In an aspect of this embodiment, the identifying information identifies other song(s) that follow the next song in the playlist. The identifying information may be textual, graphical, etc. or any combination thereof.

In a thirteenth example embodiment, the designated virtual element is a virtual button configured to, upon activation of the designated virtual element, skip back to a previous song in a playlist of songs. In accordance with this embodiment, providing the preview at step 1904 includes providing identifying information that identifies the previous song. In an aspect of this embodiment, the identifying information identifies other song(s) that precede the previous song in the playlist.

In a fourteenth example embodiment, the designated virtual element is a virtual button configured to, upon activation of the designated virtual element, cause a previously viewed webpage to be displayed. In accordance with this embodiment, providing the preview at step 1904 includes providing identifying information that identifies the previously viewed webpage. In an aspect of this embodiment, the identifying information identifies other previously viewed webpages that were viewed prior to the aforementioned previously viewed webpage.

In a fifteenth example embodiment, the designated virtual element is a hyperlink configured to, upon activation of the designated virtual element, cause a webpage to be displayed. In accordance with this embodiment, providing the preview at step 1904 includes providing a preview of the webpage. In an aspect of this embodiment, the preview of the webpage is provided without navigating away from another webpage that includes the hyperlink.

In some example embodiments, one or more steps 1902 and/or 1904 of flowchart 1900 may not be performed. Moreover, steps in addition to or in lieu of steps 1902 and 1904 may be performed. For instance, in a sixteenth example embodiment, flowchart 1900 further includes detecting finger(s) in a hover position with respect to the touch screen. The finger(s) are a spaced distance from the touch screen. In accordance with this embodiment, detecting the gesture at step 1902 includes detecting a hover gesture. The hover gesture occurs without the finger(s) touching the touch screen.

As shown in FIG. 20, the method of flowchart 2000 begins at step 2002. In step 2002, finger(s) are detected in a hover position. The finger(s) are a spaced distance from a touch screen. In an example implementation, touch screen sensor 210 detects the finger(s) in the hover position. In accordance with this implementation, the finger(s) are a spaced distance from touch screen 132. For instance, the finger(s) may be a spaced distance from touch screen sensor 210 on touch screen 132.

At step 2004, a hover gesture is detected with regard to a virtual element on the touch screen. The hover gesture is a user command to perform an action associated with the virtual element. The hover gesture occurs without touching the touch screen. In an example implementation, gesture engine 212 detects the hover gesture with regard to the virtual element.

At step 2006, the action is performed based on the hover gesture. Performing the action may include but is not limited to causing the virtual element to shake, vibrate, ripple, twist, etc. Some other example actions are described in greater detail below with respect to various embodiments. In an example implementation, operating system and/or rendering engine 216 perform the action based on the hover gesture.

In a first example embodiment, the virtual element is a photograph of a person. The photograph may appear in a list of contacts, each contact corresponding to a respective person. For instance, each contact may include a respective photograph of the respective person. In accordance with this embodiment, performing the action at step 2006 includes displaying information that indicates one or more methods of communication (e.g., telephone call, SMS, IM, email, etc.) by which the person is reachable.

In a second example embodiment, the virtual element represents a caller associated with a call in a list of received calls. In accordance with this embodiment, performing the action at step 2006 includes displaying information that indicates one or more methods of communication, in addition to or in lieu of a telephone call, by which the caller is reachable.

In a third example embodiment, the virtual element is an address bar in a web browser. In accordance with this embodiment, performing the action at step 2006 includes displaying a list of websites that are accessed relatively frequently with respect to other websites via the web browser. For instance, the list of websites may include a designated (e.g., predetermined) number of websites, selected from a plurality of websites, which are accessed more frequently than others of the plurality of websites via the web browser.

In a fourth example embodiment, the virtual element is a virtual button configured to, upon activation of the virtual element, answer an incoming telephone call that is received from a caller. In accordance with this embodiment, performing the action at step 2006 includes displaying a text window that is configured to receive a textual message to be sent to the caller. For instance, displaying the text window may be performed in lieu of answering the incoming telephone call.

In a fifth example embodiment, the virtual element is a timestamp of a designated email in a list of received emails. In accordance with this embodiment, performing the action at step 2006 includes replacing the timestamp with a second virtual element that is configured to, upon activation of the second virtual element, delete the designated email. For instance, the second virtual email may depict a trash can.

In a sixth example embodiment, the virtual element represents a designated email in a list of received emails. In accordance with this embodiment, performing the action at step 2006 includes displaying a list of actions that are available to be performed with respect to the designated email. Example actions include but are not limited to reply, forward, delete, etc. The list of actions may include a plurality of buttons that correspond to the respective actions.

In a seventh example embodiment, performing the action at step 2006 includes increasing a size of the virtual element. For instance, an animation may be shown in which the virtual element is unfolded (e.g., indicative of unfolding a piece of paper that is initially folded), smoothly expanded from a first size to a second size that is larger than the first size, abruptly (e.g., instantaneously) changed from the first size to the second size in response to the hover gesture being detected, etc.

In an eighth example embodiment, the virtual element is included in a plurality of virtual elements that are displayed on the touch screen. In an aspect of this embodiment, performing the action at step 2006 includes changing an arrangement of the virtual element with respect to others of the plurality of virtual elements. For example, the virtual element may be relocated from a first area of the touch screen to a second area of the touch screen that is non-overlapping with the first area. In another example, the virtual element may be expanded to an extent that other(s) of the plurality of virtual elements are moved to accommodate the expanded size of the virtual element. The virtual element may be moved up, down, left, or right within a grid that includes the plurality of virtual elements. For instance, another of the plurality of virtual elements located at a first location having first coordinates in the grid may be moved to a second location having second coordinates in the grid to accommodate the virtual element being moved to the first location.

In another aspect of this embodiment, performing the action at step 2006 includes highlighting the virtual element with respect to others of the plurality of virtual elements. Examples of highlighting the virtual element include but are not limited to brightening the virtual element, causing the virtual element to change color, adding a border along a perimeter of the virtual element, changing a font of text that is included in the virtual element (e.g., to differ from a font of text that is included in other(s) of the plurality of virtual elements), highlighting text that is included in the virtual element, increasing a size of text that is included in the virtual element, bolding text that is included in the virtual element, decreasing brightness of other(s) of the plurality of virtual elements, increasing transparency of other(s) of the plurality of virtual elements, shading other(s) of the plurality of virtual elements, etc.

In a ninth example embodiment, performing the action at step 2006 includes magnifying a portion of content in the virtual element that corresponds to a location of the finger(s) with respect to the touch screen. For example, if the virtual element is an email, a portion of the text in the email may be magnified as the finger(s) move over the portion. In another example, if the virtual element is a web page, a portion of the text in the web page may be magnified as the finger(s) move over the portion. In an aspect of this embodiment, the portion of the content may be magnified to an increasingly greater extent as the hover gesture continues to be detected with regard to the portion of the content. For instance, the portion of the content may be magnified to an increasingly greater extent until the content reaches a threshold size, at which point the portion may not be magnified further.

In a tenth example embodiment, the virtual element includes a front side and a backside. In accordance with this embodiment, performing the action at step 2006 includes flipping over the virtual element to show the backside and displaying information regarding the virtual element on the backside that is not shown on the front side prior to the virtual element being flipped over.

For example, the front side may identify a news source, and the backside may show headlines of respective articles that are available from the news source. In another example, the front side may show a headline, and the backside may show an article that corresponds to the headline. In yet another example, the front side may identify a movie provider, and the backside may show movie titles of respective movies that are available from the movie provider.

In still another example, the front side may identify an email, song, or movie, and the backside may indicate a plurality of actions that are available with respect to the email, song, or movie. In accordance with this example, the backside may show a plurality of control buttons corresponding to the respective actions. In further accordance with this example, if the front side identifies an email, the plurality of control buttons may include a forward button configured to, upon selection of the forward button, forward the email to one or more persons, a reply button configured to, upon selection of the reply button, generate a response email to be sent to a sender of the email, and so on. In further accordance with this example, if the front side identifies a song or movie, the plurality of control buttons may include a pause button configured to, upon selection of the pause button, pause the song or movie, a stop button configured to, upon selection of the stop button, stop the song or movie, a rewind button configured to, upon selection of the rewind button, rewind the song or movie, a fast forward button configured to, upon selection of the fast forward button, fast forward the song or movie, a play speed button configured to, upon selection of the play speed button, enable a user to change a speed at which the song or movie plays, and so on.

In some example embodiments, one or more steps 2002, 2004, and/or 2006 of flowchart 2000 may not be performed. Moreover, steps in addition to or in lieu of steps 2002, 2004, and/or 2006 may be performed.

As shown in FIG. 21, the method of flowchart 2100 begins at step 2102. In step 2102, a hover gesture is detected with regard to a virtual element on a touch screen. The hover gesture is a user command to perform an action associated with the virtual element. The hover gesture occurs without touching the touch screen. In an example implementation, gesture engine 212 detects the hover gesture with regard to the virtual element on the touch screen (e.g., touch screen 132).

At step 2104, the action is performed based on the hover gesture. In an example implementation, operating system and/or rendering engine 216 perform the action based on the hover gesture.

In a first example embodiment, the virtual element indicates that a song is being played. In accordance with this embodiment, the song is included in a playlist of songs. In an aspect of this embodiment, performing the action at step 2104 includes skipping (e.g., manually skipping) to a next consecutive song in the playlist. In another aspect of this invention, performing the action at step 2104 includes skipping back to a previous consecutive song. The hover gesture may be an air swipe or any other suitable type of hover gesture. For instance, an air swipe in a first direction may cause skipping to the next consecutive song, and an air swipe in a second direction that is opposite the first direction may cause skipping back to the previous consecutive song.

In a second example embodiment, the virtual element indicates that an incoming telephone call is being received. In accordance with this embodiment, performing the action at step 2104 includes answering the incoming telephone call in a speaker mode of a device that includes the touch screen. The speaker mode is selected in lieu of a normal operating mode of the device based on the hover gesture. The normal operating mode is a mode in which the device is placed proximate an ear of the user. The speaker mode is configured to provide audio of the incoming telephone call at a relatively high sound intensity to a user of the device to compensate for a relatively greater distance between the device and the ear of the user. The normal operating mode is configured to provide the audio of the incoming telephone call at a relatively lower sound intensity to the user to accommodate a relatively lesser distance between the device and the ear of the user. The hover gesture may be a palm wave or any other suitable type of hover gesture. For instance, answering the incoming telephone call in this manner may enable hands-free operation of the device (e.g., while the user is driving).

In a third example embodiment, the virtual element is a photograph. In accordance with this embodiment, performing the action at step 2104 includes traversing (e.g., manually traversing) through a plurality of photographs that includes the photograph. The hover gesture may be an air swipe or any other suitable type of hover gesture.

In a fourth example embodiment, the virtual element is a calendar. In accordance with this embodiment, performing the action at step 2104 includes traversing (e.g., manually traversing) through a plurality of viewing modes of the calendar. The plurality of viewing modes including at least a day mode and a month mode. The day mode is configured to show calendar entries for a specified date. The month mode is configured to show calendar entries for a specified month. It will be recognized that other gesture(s) may be used to navigate between days when the calendar is in the day mode, navigate between weeks when the calendar is in a week mode, navigate between months when the calendar is in the month mode, and so on.

In a fifth example embodiment, the virtual element depicts at least one active chat session of a plurality of active chat sessions. In accordance with this embodiment, performing the action at step 2104 includes switching between chat sessions of the plurality of chat sessions.

In a sixth example embodiment, the virtual element represents a web browser. The web browser shows a plurality of tabs associated with a plurality of respective web pages. In accordance with this embodiment, performing the action at step 2104 includes switching between web pages of the plurality of web pages. For example, displaying a first web page of the plurality of web pages may be discontinued, and displaying a second web page of the plurality of web pages may be initiated. In accordance with this example, a depiction of the first web page on the touch screen may be replaced with a depiction of the second web page.

In a seventh example embodiment, performing the action at step 2104 includes stopping an animation of the virtual element. For instance, stopping the animation may include muting the animation, stopping movement of the virtual element, etc. In an aspect of this embodiment, the animation may be restarted based on a determination that the hover gesture is discontinued or based on a detection of a second hover gesture with regard to the virtual element.

In some example embodiments, one or more steps 2102 and/or 2104 of flowchart 2100 may not be performed. Moreover, steps in addition to or in lieu of steps 2102 and/or 2104 may be performed.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any one or more of the components 102 shown in FIG. 1, rendering engine 216, gesture engine 212, flowchart 1700, flowchart 1800, flowchart 1900, flowchart 2000, and/or flowchart 2100 may be implemented in hardware, software, firmware, or any combination thereof.

For example, any one or more of components 102, rendering engine 216, gesture engine 212, flowchart 1700, flowchart 1800, flowchart 1900, flowchart 2000, and/or flowchart 2100 may be implemented as computer program code configured to be executed in one or more processors.

For clarity, only certain selected aspects of the software-based and firmware-based implementations are described. Other details that are well known in the art are omitted. For example, it should be understood that the disclosed technology is not limited to any specific computer language or program. For instance, the disclosed technology can be implemented by software and/or firmware written in C++, Java, Perl, JavaScript, Adobe Flash, or any other suitable programming language.

In another example, any one or more of components 102, rendering engine 216, gesture engine 212, flowchart 1700, flowchart 1800, flowchart 1900, flowchart 2000, and/or flowchart 2100 may be implemented as hardware logic/electrical circuitry.

For instance, in an embodiment, one or more of components 102, rendering engine 216, operating system 214, gesture engine 212, touch screen sensor 210, flowchart 1700, flowchart 1800, flowchart 1900, flowchart 2000, and/or flowchart 2100 may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### III. Example Computer System

FIG. 22 depicts an example computer 2200 in which embodiments may be implemented. For instance, mobile device 100 shown in FIG. 1 may be implemented using computer 2200, including one or more features of computer 2200 and/or alternative features. Computer 2200 may be a general-purpose computing device in the form of a conventional personal computer, a mobile computer, or a workstation, for example, or computer 2200 may be a special purpose computing device. The description of computer 2200 provided herein is provided for purposes of illustration, and is not intended to be limiting. Embodiments may be implemented in further types of computer systems, as would be known to persons skilled in the relevant art(s).

As shown in FIG. 22, computer 2200 includes a processing unit 2202, a system memory 2204, and a bus 2206 that couples various system components including system memory 2204 to processing unit 2202. Bus 2206 represents one or more of any of several types of bus structures, including a memory bus or memory controller, a peripheral bus, an accelerated graphics port, and a processor or local bus using any of a variety of bus architectures. System memory 2204 includes read only memory (ROM) 2208 and random access memory (RAM) 2210. A basic input/output system 2212 (BIOS) is stored in ROM 2208.

Computer 2200 also has one or more of the following drives: a hard disk drive 2214 for reading from and writing to a hard disk, a magnetic disk drive 2216 for reading from or writing to a removable magnetic disk 2218, and an optical disk drive 2220 for reading from or writing to a removable optical disk 2222 such as a CD ROM, DVD ROM, or other optical media. Hard disk drive 2214, magnetic disk drive 2216, and optical disk drive 2220 are connected to bus 2206 by a hard disk drive interface 2224, a magnetic disk drive interface 2226, and an optical drive interface 2228, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 2230, one or more application programs 2232, other program modules 2234, and program data 2236. Application programs 2232 or program modules 2234 may include, for example, computer program logic for implementing any one or more of components 102, rendering engine 216, gesture engine 212, flowchart 1700 (including any step of flowchart 1700), flowchart 1800 (including any step of flowchart 1800), flowchart 1900 (including any step of flowchart 1900), flowchart 2000 (including any step of flowchart 2000), and/or flowchart 2100 (including any step of flowchart 2100), as described herein.

A user may enter commands and information into the computer 2200 through input devices such as keyboard 2238 and pointing device 2240. Other input devices (not shown) may include a microphone, joystick, game pad, satellite dish, scanner, touch screen, camera, accelerometer, gyroscope, or the like. These and other input devices are often connected to the processing unit 2202 through a serial port interface 2242 that is coupled to bus 2206, but may be connected by other interfaces, such as a parallel port, game port, or a universal serial bus (USB).

A display device 2244 (e.g., a monitor) is also connected to bus 2206 via an interface, such as a video adapter 2246. In addition to display device 2244, computer 2200 may include other peripheral output devices (not shown) such as speakers and printers.

Computer 2200 is connected to a network 2248 (e.g., the Internet) through a network interface or adapter 2250, a modem 2252, or other means for establishing communications over the network. Modem 2252, which may be internal or external, is connected to bus 2206 via serial port interface 2242.

As used herein, the terms “computer program medium” and “computer-readable storage medium” are used to generally refer to media such as the hard disk associated with hard disk drive 2214, removable magnetic disk 2218, removable optical disk 2222, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Example embodiments are also directed to such communication media.

As noted above, computer programs and modules (including application programs 2232 and other program modules 2234) may be stored on the hard disk, magnetic disk, optical disk, ROM, or RAM. Such computer programs may also be received via network interface 2250 or serial port interface 2242. Such computer programs, when executed or loaded by an application, enable computer 2200 to implement features of embodiments discussed herein. Accordingly, such computer programs represent controllers of the computer 2200.

Example embodiments are also directed to computer program products comprising software (e.g., computer-readable instructions) stored on any computer-useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technology is not limited to any particular computer or type of hardware. Certain details of suitable computers and hardware are well known and need not be set forth in detail in this disclosure.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described example embodiments, but should be defined only in accordance with the following claims and their equivalents.

What is claimed is:

1. A method comprising:
detecting a gesture with regard to a designated virtual element in a plurality of virtual elements that are displayed on a touch screen, the gesture being a user command to provide a preview of information associated with the designated virtual element; and
providing the preview of the information, without activating the designated virtual element to access the information, based on detecting the gesture with regard to the designated virtual element.

2. The method of claim 1, wherein providing the preview of the information comprises:
increasing a size of the designated virtual element to include the preview of the information.

3. The method of claim 2, wherein the plurality of virtual elements is a plurality of respective quadrilaterals;
wherein the designated virtual element is a designated quadrilateral; and
wherein providing the preview of the information comprises:
showing an animation in which the designated virtual element is unfolded from a first size to a second size, wherein the second size is greater than the first size.

4. The method of claim 1, wherein the designated virtual element represents a point of interest on a map; and
wherein providing the preview of the information comprises:
providing a magnified view of the point of interest.

5. The method of claim 1, wherein the designated virtual element is a textual representation of a day, a name, a place, an event, or an address in a textual message; and
wherein providing the preview of the information comprises:
providing a preview of information associated with the day, the name, the place, the event, or the address.

6. The method of claim 1, wherein the plurality of virtual elements represents a plurality of respective messages;
wherein the designated virtual element represents a designated message; and
wherein providing the preview of the information comprises:
providing more content of the designated message than the designated virtual element provides prior to the preview being provided.

7. The method of claim 1, wherein the designated virtual element represents a photograph; and
wherein providing the preview of the information comprises:
displaying the photograph on the touch screen.

8. The method of claim 1, wherein the plurality of virtual elements represents a plurality of respective movies;
wherein the designated virtual element represents a designated movie; and
wherein providing the preview of the information comprises:
providing a video preview of the designated movie.

9. A method comprising:
detecting a hover gesture with regard to a virtual element on a touch screen, the hover gesture being a user command to perform an action associated with the virtual element, the hover gesture occurring without touching the touch screen; and
performing the action based on the hover gesture.

10. The method of claim 9, wherein the virtual element indicates that a song is being played;
wherein the song is included in a playlist of songs; and
wherein performing the action comprises:
skipping to a next consecutive song in the playlist.

11. The method of claim 9, wherein the virtual element indicates that an incoming telephone call is being received; and
wherein performing the action comprises:
answering the incoming telephone call in a speaker mode of a device that includes the touch screen, the speaker mode being selected in lieu of a normal operating mode of the device in which the device is placed proximate an ear of the user based on the hover gesture, the speaker mode configured to provide audio of the incoming telephone call at a relatively high sound intensity to a user of the device to compensate for a relatively greater distance between the device and the ear of the user, the normal operating mode configured to provide the audio of the incoming telephone call at a relatively lower sound intensity to the user to accommodate a relatively lesser distance between the device and the ear of the user.

12. The method of claim 9, further comprising:
detecting at least one finger in a hover position, the at least one finger being a spaced distance from the touch screen;
wherein the virtual element is a photograph of a person; and
wherein performing the action comprises:
displaying information that indicates one or more methods of communication by which the person is reachable.

13. The method of claim 9, further comprising:
detecting at least one finger in a hover position, the at least one finger being a spaced distance from the touch screen;
wherein the virtual element represents a caller associated with a call in a list of received calls; and
wherein performing the action comprises:
displaying information that indicates one or more methods of communication, in addition to or in lieu of a telephone call, by which the caller is reachable.

14. The method of claim 9, further comprising:
detecting at least one finger in a hover position, the at least one finger being a spaced distance from the touch screen;
wherein the virtual element represents a designated email in a list of received emails; and
wherein performing the action comprises:
displaying a list of actions that are available to be performed with respect to the designated email.

15. The method of claim 9, further comprising:
detecting at least one finger in a hover position, the at least one finger being a spaced distance from the touch screen;
wherein the virtual element is included in a plurality of virtual elements that are displayed on the touch screen; and
wherein performing the action comprises at least one of:
changing an arrangement of the virtual element with respect to others of the plurality of virtual elements, or
highlighting the virtual element with respect to others of the plurality of virtual elements.

16. A computer program product comprising a computer-readable medium having computer program logic recorded thereon for enabling a processor-based system to perform an action based on a gesture, the computer program product comprising:
a first program logic module for enabling the processor-based system to detect at least one finger in a hover position, the at least one finger being a spaced distance from a touch screen;
a second program logic module for enabling the processor-based system to detect a hover gesture with regard to a virtual element on the touch screen, the hover gesture being a user command to perform an action associated with the virtual element, the hover gesture occurring without touching the touch screen; and
a third program logic module for enabling the processor-based system to perform the action based on the hover gesture.

17. The computer program product of claim 16, wherein the virtual element is a virtual button configured to, upon activation of the virtual element, answer an incoming telephone call that is received from a caller; and
wherein the third program logic module includes logic for enabling the processor-based system to display a text window that is configured to receive a textual message to be sent to the caller.

18. The computer program product of claim 16, wherein the virtual element is a timestamp of a designated email in a list of received emails; and
wherein the third program logic module includes logic for enabling the processor-based system to replace the timestamp with a second virtual element that is configured to, upon activation of the second virtual element, delete the designated email.

19. The computer program product of claim 16, wherein the third program logic module includes logic for enabling the processor-based system to magnify a portion of content in the virtual element that corresponds to a location of the at least one finger with respect to the touch screen.

20. The computer program product of claim 16, wherein the virtual element includes a front side and a backside; and
wherein the third program logic module includes logic for enabling the processor-based system to flip over the virtual element to show the backside and to display information regarding the virtual element on the backside that is not shown on the front side prior to the virtual element being flipped over.
